(19) United States
(12) Patent Application Publication
(10) Pub. No.: US 2019/0157724 A1
(43) Pub. Date: May 23, 2019

(54) PROCESS FOR PRODUCING AN ELECTROCHEMICAL CELL, AND ELECTROCHEMICAL CELL PRODUCED BY THE PROCESS

(71) Applicant: FRAUNHOFER-GESELLSCHAFT ZUR FÖRDERUNG DER ANGEWANDTEN FORSCHUNG E.V., Muenchen (DE)

(72) Inventors: Mareike WOLTER, Dresden (DE); Jochen SCHILM, Radebeul (DE); Kristian NIKOLOWSKI, Dresden (DE); Mihails KUSNEZOFF, Dresden (DE); Uwe PARTSCH, Dresden (DE); Christian TAG, Dresden (DE)

(73) Assignee: FRAUNHOFER-GESELLSCHAFT ZUR FÖRDERUNG DER ANGEWANDTEN FORSCHUNG E.V., Muenchen (DE)

(21) Appl. No.: 16/314,756

(22) PCT Filed: Jun. 30, 2017
(86) PCT No.: PCT/EP2017/066277

§ 371 Date: Jan. 2, 2019

(30) Foreign Application Priority Data
Jul. 1, 2016 (DE) 10 2016 212 047.6

(51) Int. Cl. H01M 10/0585; H01M 10/0525; H01M 10/0562; H01M 4/485; H01M 4/58; H01M 4/04

(52) U.S. Cl. CPC H01M 10/0585; H01M 10/0525; H01M 10/0562; H01M 2300/0071; H01M 4/5825; H01M 4/0471; H01M 4/0407; H01M 4/485

(57) ABSTRACT

The invention relates to a process for producing an electrochemical cell, particularly a solid-electrolyte battery, wherein a paste or foil is applied to each of the opposing surfaces of a solid electrolyte that form the respective anode and the respective electrode, and organic components within the pastes or foils are expelled in a heat treatment under an inert or reducing atmosphere. Subsequent to this, in a further stage, a fusional connection is produced by sintering between the anode and the solid electrolyte and between the cathode and the solid electrolyte. Here, the solid electrolyte is formed with an oxidic material conductive for lithium ions, the anode with a first lithium-containing chemical compound, particularly lithium titanate, and carbon, and the cathode with a second lithium-containing chemical compound, particularly a lithium metal phosphate, and carbon, to give a three-layer electrochemical cell construction devoid of organic components.

The invention relates to a process for producing an electrochemical cell and also to an electrochemical cell produced by the process, in particular a solid-state battery in which lithium-based electrodes are present.

Solid-state batteries have a series of advantages over Li batteries having a liquid electrolyte. These are, in particular:
(i) better thermal stability and
(ii) a lower risk to the environment (liquid electrolyte is toxic and corrosive)
(iii) no risk of fire due to the absence of organic constituents.

Known solid-state batteries consist of an ion-conducting solid electrolyte, a cathode and an anode which are bonded to the electrolyte. Electrodes of the solid-state battery consist of the active material, lithium ion conductor and graphite (carbon black or other type of carbon). The graphite component in particular is important for outward conduction of electrons and contact with the current collector connection.

The following challenges have to be addressed in realizing solid-state batteries:
good mechanical and electrical bonding of the electrodes to the solid electrolyte material
minimized thermomechanical stresses in the material-to-material bond between electrodes and solid electrolytes resulting from production and operation
low ohmic resistances in the electrodes.

Sintering of the electrodes onto the electrolyte material appears to be the simplest method of realizing the solid electrolyte battery which achieves the required properties. However, sintering temperatures of >400° C. are necessary for this purpose. Graphite as constituent of the electrodes is no longer stable in air at or above about 300° C. and the conventional cathodes for lithium ion batteries, consisting of a porous, organically bonded granular active material (e.g. NCM—lithium-nickel-manganese-cobalt oxide), decompose in an inert or reducing atmosphere at or above about 500° C.

No published solution to the above-described problems in which either cathode, anode and the solid electrolyte are sintered simultaneously in one step or cathode and anode are sintered onto a presintered solid electrolyte is known.

It is therefore an object of the invention to produce electrochemical cells, in particular in the form of a solid-state battery, by means of a sintering process and at the same time avoid decomposition of the significant components of the electrode materials.

This object is achieved according to the invention by a process having the features of claim 1. An electrochemical cell produced by the process is the subject matter of claim 8. Advantageous embodiments and further developments of the invention can be realized by means of features specified in dependent claims.

The present invention relates to joint sintering of electrodes with the solid electrolyte (in the extreme case cosintering of all components) under reducing or inert conditions in order not to decompose the respective carbon components of the respective electrode material.

To realize a solid-state battery in this way, the selection of material for electrolyte and electrodes is important. Only chemical compounds which are stable with respect to the reducing conditions at temperatures of >400° C. are suitable. These compounds include, for example, the lithium ion-conducting solid electrolyte Li₁₊ₓTi₂₋ₓAlₓ(PO₄)₃ (LATP) or minerals of the garnet group (lithium lanthanum zirconate with further oxides as additives) as electrolyte, Li-transition metal phosphate (LPO, transition metals are, for example, iron, cobalt, nickel, manganese) for the cathode material and Li-titanate (LTO) for the anode material.

Illustrative or possible anode and cathode materials for an anode and a cathode are set forth here.

Other combinations of intercalation materials are also possible. Cathode materials should attain an electrical potential relative to metallic lithium in the range 3 V-5.5 V and a specific charge density in the range 120 Ah/kg-300 Ah/kg. Anode materials should attain an electrical potential relative to metallic lithium in the range 0 V-1.8 V and a specific charge density in the range 120 Ah/kg-500 Ah/kg.

The solid electrolyte can be used as presintered substrate composed of lithium ion-conducting material (e.g. LATP or garnet types) or as an unsintered sheet which comprises the respective particles which form a lithium ion-conducting material after sintering.

The cathode and anode are produced as composite composed of three materials. These are an active phase (e.g. a first lithium-containing chemical compound, in particular LPO for the cathode, with the metal being able to be, for example, Fe, Co, Mn or Ni, and a second lithium-containing chemical compound, in particular LTO for the anode), carbon (e.g. graphite) and an ion conductor (e.g. LATP, mineral garnet, lithium ion-conducting glass or another lithium ion-conducting material) for the solid electrolyte.

The solid-state components for the solid electrolyte and the electrodes in particle form can be processed with organic solvents and binders to form a sheet or paste in each case. The anode and cathode sheet/paste can be applied to the surface of the electrolyte.

The two electrodes are subsequently sintered together with the electrolyte as substrate under inert (in a nitrogen atmosphere) or reducing conditions (hydrogen or nitrogen/hydrogen gas mixtures) at temperatures of 400° C. In the heat treatment, binder removal (removal of the organic components apart from the carbon) occurs first and sintering then occurs. The organic constituents of the electrode materials, as starting material for the sheets or pastes, should be burnt out very completely or be converted into electronically conductive and percolating carbon phases. This results in a solid-state battery having a material-to-material bond between all components of such an electrochemical cell, in which carbon is present as electron-conducting phase and a percolating ion conductor in the microstructure of the electrode materials in a proportion above the percolation threshold.

The in-principle procedure can in the simplest case be applied to a contiguous monolithic composite cathode and anode. In particular cases, other embodiments appear to be more suitable for minimizing thermomechanical stresses in the bond to the ionically conducting barrier layer, i.e. the solid electrolyte, and also as a result of the lithium incorporation and release reactions during the electric charging and discharging processes of the electrochemical cell.

FEM simulation calculations have shown that a critical mechanical stress maximum can occur directly at the interfaces due to incorporation and release reactions of lithium in the active material of the electrodes. Elements of the respective electrode layers which have been laterally segmented by means of the sintering-on enable any mechanical stresses occurring to be limited to the respective segments and therefore to be distributed. In this way, the resulting stress maxima can be reduced at the interfaces to the solid electrolyte which separates the electrodes from one another and more uniform distribution of the mechanical stresses in the cell structure can be achieved.

Such segments for an anode or electrode should have an area in the range from 0.03 mm² to 3.4 mm² and distances from one another of at least 0.05 μm to 200 μm. The individual segments on a surface of the solid electrolyte can be electrically conductively joined to one another. For this purpose, it is possible to use suitable pastes known per se which comprise electrically conductive particles and organic constituents before the heat treatment. The organic components present therein should be driven off very completely in a first stage of the heat treatment and the electrically conductive particles, in particular silver, should be sintered to one another. In this way, electrically conductive conductor tracks can be formed between segments, by means of which segments can be electrically connected in series or in parallel.

To produce the pastes or sheets by means of which at least one layer forming the solid electrolyte, the anode and/or the cathode, organic components, in particular organic solvents and binders, should be used in a proportion of from 25% by volume to 60% by volume.

Either alone or in addition thereto, a paste or sheet containing carbon, in particular in the form of graphite, in a proportion in the range from 3% by volume to 15% by volume can be used to form an anode and/or cathode.

In addition to the carbon, a first and a second lithium-containing pulverulent chemical compound and pulverulent carbon can be used in addition to the organic components in the form of a sheet or paste to produce an electrolyte and electrode material. The solid particles of the pulverulent materials or of the carbon should have an average particle size d₅₀ in the range from 0.05 μm to 10 μm.

To produce the electrochemical cell, sheets having a layer thickness in the range from 10 μm to 220 μm after sintering are used or pastes for forming a respective electrode having a layer thickness in the range from 5 μm to 100 μm after sintering are applied to a surface of a solid electrolyte substrate. The production of organically bound sheets and pastes from the powder mixtures is described in detail in the working examples. The organic component of the sheets and pastes is decomposed and completely or partly removed during the sintering process.

Compared to known structures of solid-state batteries, the above-described structure of the electrochemical cells produced in this way contains only a small amount, if any, of organic constituents which could catch fire, e.g. in the case of damage or overloading. No organic compounds or at most 5% by volume of such chemical compounds should be present.

Compared to known purely inorganic solid-state batteries, the method of production described makes it possible to produce a structure having good material-to-material, electronically and ionically conductive bonding of all layers (cathode, solid electrolyte, anode).

In the formation of the material-to-material bond between the solid electrolyte and the electrodes, lithium from the respective electrode can advantageously be incorporated into the region close to the surface of the solid electrolyte material, as a result of which a gradated transition of the lithium content in the interfacial regions can be obtained.

Due to cosintering in an inert or reducing atmosphere, carbon remains present to a sufficient extent as electronically conducting phase in the microstructure.

Of course, it is also possible to use a plurality of electrochemical cells produced according to the invention which are arranged above one another and/or next to one another. These can then, in particular, as explained below in the description of examples, in a heat treatment, jointly firstly be subjected to binder removal and then joined to one another by a material-to-material bond by means of sintering. Thus, for example, a stack of a plurality of superposed electrochemical cells produced according to the invention, between which electrically insulating layers or electrically conductive interconnects have optionally been formed or arranged in a form known per se, can be made available so that, for example, an increased electrical potential can be achieved by means of suitable electric connection of the electrochemical cells with one another.

The invention will be illustrated below with the aid of working examples.

### EXAMPLE 1

### Cosintering of Anode and Cathode to a Presintered Solid Electrolyte Substrate

To produce the electrochemical cell, a sintered, Li ion-conducting substrate composed of a garnet material of the lithium lanthanum zirconate (LLZO) type with suitable oxidic dopants, in particular Al₂O₃, Nb₂O₅, Ta₂O₅, is used. Corresponding materials are commercially available as powder (hereinafter this substrate will be referred to as solid electrolyte). A paste forming the anode and a paste forming the cathode are applied as layer to the opposite surfaces of a previously sintered solid electrolyte. The respective pastes are produced from the following solid components:

Cathode paste: LiCOPO₄ in an amount of 25% by volume-30% by volume, graphite in an amount of 5% by volume-10% by volume, LATP glass in an amount of 15% by volume-20% by volume, organic binder (e.g. ethyl or methyl cellulose, acetates, polyacrylates) in an amount of up to 10% by volume and optionally further typical organic additives such as plasticizers and dispersants and a volatile solvent (e.g. alcohols, hydrocarbons, esters, ethers)

anode paste: LTO in an amount of 25% by volume-30% by volume, graphite in an amount of 5% by volume-10% by volume, LATP glass in an amount of 15% by volume-20% by volume, organic binder (e.g. ethyl or methyl cellulose, acetates, polyacrylates) in an amount of up to 10% by volume and optionally further typical organic additives such as plasticizers and dispersants and a volatile solvent (e.g. alcohols, hydrocarbons, esters, ethers)

The abbreviation LATP refers to a lithium ion-conducting compound of the type Li₁₊ₓTi₂₋ₓAlₓ(PO₄)₃=LATP, which is used as oxidic starting powder in the examples described either in pure form or as part of mixtures. This material can be sintered at temperatures above 700° C. to give an ion-conductive ceramic.

The pastes are each applied over the full area of the opposite substrate surfaces and dried at 75° C. and subsequently at 120° C. for about 30 minutes in each case. The solid electrolyte printed with the two pastes is laid on a sintering aid composed of porous SiC and heat treated at from 400° C. to 500° C. under a protective gas atmosphere (N₂). The heat treatment is designed so that firstly binder removal or partial pyrolysis of the organic components present in the pastes occurs in a temperature stage 1 (<500° C.). In the further heat treatment above the temperature stage 1, the electrode materials densify and sinter to the solid electrolyte as substrate and thus produce a material-to-material, Li ion-conducting and intercalating connection of the cathode layer and the anode layer to the solid electrolyte layer. The arrangement obtained represents an uncontacted functional electrochemical cell of a fully inorganic solid-state battery.

### EXAMPLE 2

### Cosintering of Anode, Cathode and the Solid Electrolyte Substrate

To produce this type of solid-state battery, three unsintered sheets are used:

Sheet 1 or electrolyte sheet: Sheet consisting of 60% by volume-80% by volume of LATP, 1.5-5% by volume of sintering additive (e.g. LiNO₃, Li₃PO₄ and further lithium-based salts) and 15% by volume-38.5% by volume of organics and having a thickness of 10 μm-50 μm.

Sheet 2 or cathode sheet: Sheet consisting of 50% by volume-60% by volume of LiFePO₄, 5% by volume-10% by volume of graphite, 15% by volume-20% by volume of LATP, 15% by volume-38.5% by volume of organics and having a thickness of 10 μm-220 μm.

Sheet 3 or anode sheet: Sheet consisting of 50% by volume-60% by volume of LTO, 5% by volume-10% by volume of graphite, 15% by volume-20% by volume of LATP glass, 15% by volume-38.5% by volume of organics and having a thickness of 10 μm-150 μm.

The term organics in the abovementioned sheet formulations refers to suitable mixtures of organic compounds by means of which it is possible to convert the oxidic particles into sheet-like structures and bind them. The following compounds can typically but not exclusively be present in the organics:

Binder: Polyvinyl butyral, polyvinyl alcohol, polypropylene carbonate, polymethyl methacrylate, polyvinylidene fluoride, alginates, celluloses, epoxy resins, UV-curing binders

Solvent: Water, ethanol, acetone, toluene, methyl ethyl ketone, butanol, isopropanol, ethyl acetate, N-methyl-2-pyrrolidone; azeotropic mixtures (ethanol/methyl ethyl ketone/toluene; methyl isobutyl ketone/methanol; isopropanol/ethyl acetate; butanol/toluene; MEK/toluene/cyclohexanone)

Dispersant: Polyester, polyamine, fish oil;

Plasticizer: Benzyl butyl phthalate, polyethylene glycol, dibutyl phthalate, diisononyl phthalate, polyalkylene glycol, dioctyl phthalate

The films are joined by means of a pressure-assisted process (optionally at slightly elevated temperatures up to 100° C.) to produce a laminate formed of three layers and the composite obtained is cut to a suitable final size. The cut-to-size laminates are laid on planar sintering aids (e.g. SiC, Hexoloy, vitreous carbon or Al₂O₃) and sintered at temperatures in the range from 900° C. to 1150° C. under protective gas as inert atmosphere (e.g. nitrogen). The heat treatment is designed so that firstly removal of the sheet organics present as binders firstly occurs in a first temperature stage 1 (<500° C.). In the further heat treatment as second temperature stage 2 above the temperature stage 1, the laminated sheet composite is sintered together so as to form a material-to-material, Li ion-conducting and intercalating bond between the cathode, solid electrolyte and anode layers. Here, the LATP solid electrolyte densifies and forms a very dense solid electrolyte layer in the middle composite layer. At the same time, the LATP phases in the two electrode layers (anode and cathode) densify and form a material-to-material and lithium ion-conductive bond to the solid electrolyte layer. The arrangement obtained represents an uncontacted functional electrochemical cell of a solid-state battery consisting entirely of inorganic materials.

### EXAMPLE 3

### Cosintering of Segmented Anode and Segmented Cathode to a Presintered Solid Electrolyte Substrate

Based on the information given in example 1, the cathode and anode pastes are printed in a suitably segmented layout on the opposite surfaces of a presintered solid electrolyte substrate. A solid electrolyte is thus coated with a plurality of regions which are at a certain distance from one another. The ratio of the distances between the segments to the size of the segments has to be selected so that the volume expansion of the composite electrode segments caused by the incorporation and release of lithium in the active material of the respective electrode material is compensated for. The further process steps are the same as in example 1.

### EXAMPLE 4

### Cosintering of Segmented Anode and Segmented Cathode with the Solid Electrolyte Substrate

Based on the information given in example 2, a plurality of segments each consisting of cathode and anode sheets with suitable distances between one another are laminated onto the opposite surfaces of the sheet containing the solid electrolyte material as substrate. The ratio of the distances between the individual segments to the size of the segments has to be selected so that the volume expansion of the composite electrode segments caused by the incorporation and release of lithium in the active material is compensated for. The further process steps are the same as in example 2.

In these working examples, the material class of the LATP, as described in the examples, is merely an example of a solid electrolyte material which can perform various functions in a solid-state battery. It can firstly be used as independent solid electrolyte layer having a separator function for the spatial and electrochemical separation of the electrodes. Furthermore, the material is present as part of the electrodes and there forms, after the heat treatments, a percolating electrolyte structure which takes on the task of ion transport from and to the active materials of the electrodes.

The above-described LATP is merely an example of a variety of lithium ion-conductive and oxidic materials which can be employed in the present invention. As an alternative, it is also possible, for example, to use the following classes of compounds:
lithium ion-conducting glasses (lithium-borate-based, lithium-phosphate-based types)
crystalline lithium borates
antiperovskites (e.g. Li₃OCl, Li₃O(Cl_{0.5}Br_{0.5}) or perovskite compounds of the Li₃O A_{1-z}A′_{z} type)

The heat treatment steps for the composite materials forming the solid electrolyte and the electrodes should be adapted in an appropriate manner as a function of the melting and softening temperatures of these chemical compounds.

1. A process for producing an electrochemical cell, in particular a solid electrolyte battery, wherein
a paste or sheet which in each case forms the respective anode and the respective electrode is applied to each of the opposite surfaces of a solid electrolyte and, in a heat treatment in an inert or reducing atmosphere, organic components which are present in the pastes or sheets are driven off and then, in a further stage, a material-to-material bond is produced between the anode and the solid electrolyte and between the cathode and the solid electrolyte by means of sintering; where
the solid electrolyte comprising a lithium ion-conductive and oxidic material, the anode comprising a first chemical compound, in particular lithium titanate, and carbon and the cathode comprising a second lithium-containing chemical compound, in particular a lithium-metal phosphate, and carbon are formed, so that
an electrochemical cell structure which has in each case three layers and in which no organic components are present is obtained.

2. The process as claimed in claim 1, characterized in that pulverulent solid electrolyte material, anode material and cathode material are each processed with organic components to give the individual layers, so that a paste-like material in the form of a paste or sheet is in each case used for forming a respective solid electrolyte layer, anode layer and cathode layer.

3. The process as claimed in claim 1, characterized in that a lithium ion-conducting compound of the type Li₁₊ₓTi₂₋ₓAlₓ(PO₄)₃(LATP), a lithium ion-conducting glass, in particular a lithium-borate-based glass, a lithium-phosphate-based glass, a mineral garnet, an antiperovskite or a crystalline lithium borate is used for forming a solid electrolyte layer and/or
an Li-metal phosphate in which the metal is Fe, Co, Mn or Ni is used for forming the cathode layer.

4. The process as claimed in claim 1, characterized in that organic components, in particular organic solvents and binders, are used in a proportion-of from 25% by volume to 60% by volume to produce the pastes or sheets which form(s) the solid electrolyte, the anode and/or the cathode with at least one laver, and/or
a paste or sheet containing carbon, in particular in the form of graphite, in a proportion in the range from 3% by volume to 15% by volume is used for forming an anode and/or cathode.

5. The process as claimed in claim 1, characterized in that a cathode or an anode having a plurality of segments at a distance from one another is formed on at least one surface of a substrate forming the solid electrolyte and a distance by means of which the ratio of the respective distance between the segments to the size of the segments so that the volume expansion of the respective anode or cathode segments caused by the incorporation and release of lithium in the Li phosphate (LPO) and Li titanate (LTO) as active material of the respective electrode material is compensated for is adhered to is maintained between the individual segments.

6. The process as claimed in claim 1, characterized in that, for the production of the electrochemical cell, sheets having a layer thickness in the range from 10 to 220 μm are used or
pastes for forming a respective electrode having a layer thickness in the range from 5 μm to 100 μm are applied to a surface of a solid electrolyte substrate.

7. The process as claimed in claim 1, characterized in that the anode layer and/or the electrode layer is/are applied as sheet or paste to a previously sintered solid electrolyte or an unsintered or partially sintered solid electrolyte substrate and are joined by a material-to-material bond to the solid electrolyte material in the heat treatment, with lithium from the respective electrode preferably being incorporated into the region close to the surface of the solid electrolyte material.

8. An electrochemical cell produced by a process as claimed in claim 1, characterized in that no organic chemical compound or not more than 5% by volume of organic chemical compounds is present in the material of the solid electrolyte and in the electrode materials.
